(19) United States
(12) Patent Application Publication
(10) Pub. No.: US 2025/0298994 A1
(43) Pub. Date: Sep. 25, 2025

(54) REMARK-LLM: A ROBUST AND EFFICIENT WATERMARKING FRAMEWORK FOR GENERATIVE LARGE LANGUAGE MODELS

(71) Applicant: The Regents of the University of California, Oakland, CA (US)

(72) Inventors: Ruisi ZHANG, Oakland, CA (US); Shehzeen Samarah Hussain, Oakland, CA (US); Paarth Neekhara, Oakland, CA (US); Farinaz Koushanfar, Oakland, CA (US)

(21) Appl. No.: 19/088,888

(22) Filed: Mar. 24, 2025

Related U.S. Application Data
(60) Provisional application No. 63/568,643, filed on Mar. 22, 2024.

(51) Int. Cl. G06F 40/40; G06F 40/284

(52) U.S. Cl. CPC G06F 40/40; G06F 40/284

(57) ABSTRACT

In some embodiments, there is provided a method that includes receiving an output text sequence from a trained large language model; converting the output text sequence into a token representation of the output text sequence; generating a dense watermarked text distribution over a token vocabulary of the output text sequence, the generating based on the token representation of the output text sequence and on a binary signature sequence; perturbing the dense watermarked text distribution to yield a perturbed distribution; and mapping the perturbed distribution to an encoded output text sequence. Related systems, methods, and articles of manufacture are also disclosed.

### CROSS-REFERENCE TO RELATED

This application claims the benefit of priority under 35 U.S.C. § 119 (e) to U.S. Provisional Patent Application No. 63/568,643, titled “ReMark-LLM: A Robust and Efficient Watermarking Framework for Generative Large Language Models” and filed on Mar. 22, 2024, the contents of which are hereby incorporated by reference in their entirety.

### SUMMARY

In some example embodiments, there may be provided watermarks for generative large language models (LLMs).

In some embodiments, there is provided a method that includes receiving an output text sequence from a trained large language model; converting the output text sequence into a token representation of the output text sequence; generating a dense watermarked text distribution over a token vocabulary of the output text sequence, the generating based on the token representation of the output text sequence and on a binary signature sequence; perturbing the dense watermarked text distribution to yield a perturbed distribution; and mapping the perturbed distribution to an encoded output text sequence. Related systems, methods, and articles of manufacture are also disclosed.

In some variations, the receiving, the converting, and the generating are caused to be performed by an encoding module, and wherein the perturbing and the mapping are caused to be performed by an optimization beam search module. The token representation of the output text sequence comprises a plurality of tokens, each of the plurality of tokens representing a corresponding portion of text of the output text sequence. The dense watermarked text distribution comprises, for each of the plurality of tokens, an associated probability indicative of how the corresponding portion of text maps to the encoded output text sequence. The perturbing comprises adding noise to the dense watermarked text distribution. The noise comprises Gumbel-Softmax noise. The reparametrizing the dense watermarked text distribution is over the token vocabulary of the output text sequence to a yield a sparse distribution. A reparameterization module causes the reparametrizing.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1A and 1B illustrate systems in accordance with some embodiments described herein;

FIG. 2 illustrates a method in accordance with some embodiments described herein; and

FIG. 3 illustrates a computing system in accordance with some embodiments described herein.

### DETAILED DESCRIPTION

Synthesizing human-like content using LLMs necessitates vast computational resources and extensive datasets, encapsulating critical intellectual property (IP). However, the generated content is prone to malicious exploitation, including spamming and plagiarism. Existing literature on text watermarking can be classified into three categories: (1) rule-based watermarking, (2) inference-time watermarking, and (3) neural-based watermarking. The rule-based watermarking replaces synonym or transforms syntactic structures in the paragraph to insert as watermarks. Such manually designed features make the inserted signatures statistically removable through word distribution or syntactical analysis. The inference-time watermarking splits vocabulary into green/red lists and restricts the LLM decoding to predict the next tokens from the green list. While the inserted watermarks are robust against attacks, the decoding strategy drastically distorts the semantic similarity between the watermarked and original LLM outputs. The neural-based approach leverages an end-to-end learning technique to integrate the binary watermarking signatures into the LLM-generated texts while maintaining semantic coherence. However, the maximum encodable signature length per token segment is limited compared with the rule-based and inference-time frameworks, thus hindering the practical usage of this approach.

Generally speaking, watermarking text data presents several challenges. First, text data exhibits a pronounced sparsity compared with other modalities, such as images and audio. For instance, a 256-pixel image offers approximately 65 k feasible positions for watermark insertion, whereas the maximum token limit in GPT-4 is 8.2 k. Besides, text data is fragile in that subtle alterations may obfuscate or compromise the semiotic fidelity, whereas minor perturbations in images can remain imperceptible. In other words, relative to image data, text data exhibits a heightened sensitivity to alterations.

Watermarking offers a promising solution to tackle two persistent issues: asserting ownership of generated output and tracing the source of content. By embedding watermark signatures into the outputs of LLMs, model proprietors can effectively monitor their content utilizations and validate their ownership.

Described herein are systems and methods of signature insertion comprising a learning-based message encoding module to infuse binary signatures into LLM-generated texts. The message encoding module encodes the LLM-generated texts and their corresponding signatures into latent feature space. Their feature representations are added and yield the watermarked distribution over the vocabulary.

The systems and methods of signature insertion described herein may further comprise a reparameterization module to transform the dense distributions from the message encoding to the sparse distribution of the watermarked textual tokens. The reparameterization module may be configured to exploit Gumbel-Softmax methodology to transform the watermarked distribution to the sparse distribution of the watermarked textual tokens.

The systems and methods of signature insertion described herein may further comprise a decoding module dedicated for signature extraction. The decoding module may be configured to extract watermarking signatures by leveraging a transformer to predict the inserted messages.

Furthermore, there is described an optimized beam search algorithm to guarantee the coherence and consistency of the generated content.

The signature insertion systems and methods described herein preserve semantic integrity in watermarked content, while ensuring effective watermark retrieval. Further, the signature insertion systems and methods described herein result in signatures that exhibit better resilience against a spectrum of watermark detection and removal attacks. The systems and methods described herein enhance robustness by incorporating malicious transformations during training, including text addition, deletion, and substitution over the transformed textual token distribution into the message decoding phase. For example, three modules may be trained end-to-end, targeting to (1) preserve the semantic fidelity by minimizing a semantic loss between the original LLM-generated and watermarked texts, (2) ensure watermark extraction by minimizing a message recovery loss between the inserted and extracted watermarking signatures from the watermarked texts, and (3) enhance robustness by extracting watermarking signatures from the malicious transformations.

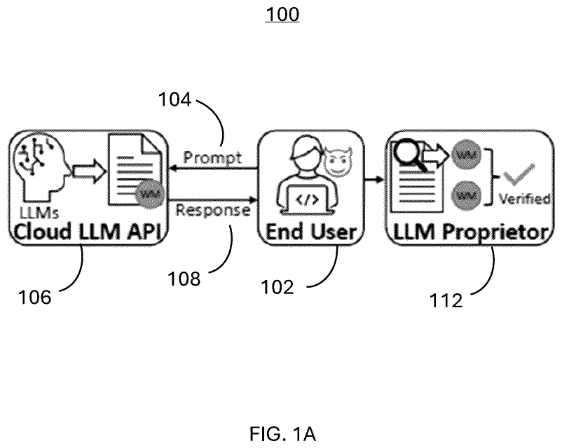

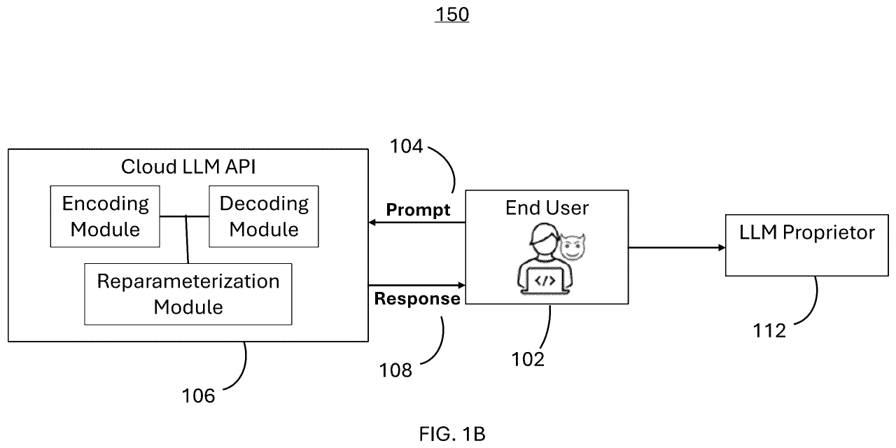

FIG. 1A illustrates a system 100 in accordance with some embodiments described herein. A user can interact with system 100 via a client 102 device (also referred to herein as “client). The client 102 may comprise, for example, a laptop, a smartphone, or a virtual home assistant. The user may, via the client 102, submit a prompt 104 to a large language model hosted in a remote cloud 106. The cloud 106 may, for example, host a neural network (e.g., a large language model (LLM), a sequence-to-sequence (Seq2Seq) model, and/or the like. The Seq2Seq model may comprise a neural network configured to process sequential data. For example, the Seq2Seq model may be configured to accept a sequence of data as an input and to provide a sequence of data as an output. The large language model may output a response 108 having an inserted signature (e.g., a watermark) therein. The response 108 having the inserted signature therewithin may be output to the user via the client 102.

As shown in FIG. 1B, the cloud 106 may be configured to host a message encoding module and a message decoding module. The message encoding module hosted by the cloud 106 may be configured to receive an output text sequence from a trained machine learning model. For example, a Seq2Seq model hosted by the remote cloud 106 may be configured to provide to the message encoding module an output text sequence T={T₁, T₂, . . . Tₜ}. The message encoding module may further be configured to take as an input a binary signature sequence M.

The message encoding module hosted by the cloud 106 may be configured to convert the output text sequence into a token representation of the output text sequence. In other words, the message encoding module may further be configured to determine a corresponding latent space representation Sₑ(T) of the LLM-generated token sequence T. The latent space representation of the LLM-generated token sequence may be determined at a final normalization layer Rₙ of the encoding module hosted by the cloud 106.

The message encoding module hosted by the cloud 106 may be configured to embed binary signatures into output generated by the LLM. The message encoding module hosted by the cloud 106 may be configured to concurrently convert the output text sequence into the token representation of the output text sequence while embedding the binary signatures into the output text sequence. In other words, the signature sequence M is encoded by a linear layer Rₘ followed by the shared normalization layer Rₙ into the same latent space representation as Rₙ(M) concurrently as the message encoding module determines the corresponding latent space representation Sₑ(T) of the LLM-generated token sequence T. At the latent space, the binary signature sequences may be embedded into every token of the dense token distribution T as Sₑ(T+M).

The message encoding module hosted by the cloud 106 may further be configured to generate a dense watermarked text distribution over a token vocabulary of the output text sequence. The message encoding module hosted by the cloud 106 may be configured to generate the dense watermarked text distribution over the token vocabulary based on the token representation of the output text sequence and based on the signatures embedded into the output text sequence. The embedded latent feature Sₑ(T+M) may be directed to a decoder S_{d} of the machine learning model to obtain the watermarked distribution over the vocabulary as S(T+M). The dense watermarked text distribution may comprise, for each token in the token representation of the output text sequence, an associated probability that indicates how the token maps to encoded output text.

In some implementations, the message encoding module generates a dense token distribution over the vocabulary of the LLM output. A reparameterization module (see, e.g., FIG. 1) may be configured to transform the dense token distribution into a sparser distribution while ensuring differentiability. In certain implementations, the message decoding module extracts messages from the watermarked textual tokens' one-hot encoding.

The cloud 106 may further be configured to implement an optimized beam search algorithm to translate the output of the module's watermarked distribution into watermarked texts. In other words, a beam search algorithm may be used to generate encoded output text sequences. The beam search algorithm may be configured to perturb the dense watermarked text distribution. The beam search algorithm may be configured to perturb the dense watermarked text distribution by applying noise to at least a first probability of the dense watermarked text distribution. By applying noise to at least a first probability of the dense watermarked text distribution, the beam search algorithm adjusts the transformation of the token corresponding to the probability and generates an encoded output text sequence. In some implementations, the noise comprises Gumbel-Softmax noise.

A beam search algorithm with beam size B may produce B candidate sentences from the perturbed token distribution. For each sentence, the system 100 is configured to evaluate their extraction accuracy from the extractor in the message decoding module. A small beam size B ensures the resultant texts are highly readable, whereas the selected best-accuracy sentence guarantees the watermark extractability. The beam search is repeated for K iterations with different temperatures τₖ to obtain more diverse watermarked texts.

The optimized beam search algorithm may be configured to ensure linguistic coherence within the LLM output, unwavering semantic fidelity, and the successful extraction of signatures. After the optimized beam search algorithm is implemented, the response 108 (e.g., the watermarked LLM output) may be disseminated to at least one end-user (e.g., located the at least one client 102) as a coherent response.

In some implementations, the watermark existence can be verified within the response texts 108 by extracting the inserted signatures using a message decoder (also referred to as a message decoding module, which may be located at an LLM proprietor 112 device). The message decoder may be configured to compare the extracted messages with the inserted signatures to determine if the LLM hosted by the cloud 106 generated the texts.

To achieve the transformation from a dense token distribution to the sparser distribution, Gumbel-Softmax reparameterization may be applied as in Equation 1. In Equation 1, the watermarked distribution S(T+M) is transformed to a sparse distribution, denoted as Ŝ(T+M). S(T+M) is simplified as S. The gᵢ is the noise i.i.d samples drawn from Gumbel(0,1), |V| is the vocabulary size, and τ is the temperature for sampling. The lower τ is, the closer the reparametrized Ŝi is to one-hot encoding.

$$\hat{{𝒮}_{ι}} = \frac{exp ( ( log ( {𝒮}_{i} ) + {g}_{i} ) / τ )}{{\sum }_{j = 1}^{\vert V \vert} xp ( ( log ( {𝒮}_{i} ) + {g}_{i} ) / τ )} for i = 1 , … , \vert T \vert \qquad ( 1 )$$

In some implementations, the remote cloud 106 is configured to host a decoding module. To decode embedded M from the reparametrized distribution Ŝ(T+M), the decoding module is configured to map the reparametrized distribution into the embedding space using a linear layer Rₑ, yielding [symbol] (T+M). The [symbol] (T+M) is the watermarked text representation in the embedding space. Then, the transformer-based decoding module extracts messages from [symbol] (T+M) as M=E( [symbol] (T+M)).

The system 100 ensures robustness of the watermarks by enforcing the decoding module to learn the embeddings of the malicious transformations and to decode the same messages M from those transformations as well. The transforms, including randomly dropping, adding, and replacing tokens in the watermarked distribution, are performed over Ŝ(T+M) and get their corresponding distribution as Ŝₜ(T+M). Similar to Ŝ(T+M), the Ŝₜ(T+M) is mapped to the embedding space and extracts messages as M=F( [symbol] (T+M)).

The watermark generated via system 100 may be robust against potential attacks by an adversary. For example, if an adversary may be an end-user of the LLM cloud service who has black access to the remote cloud 106. However, the adversary may not have access to the trained watermarking models hosted by the cloud 106, nor to the original LLM-generated outputs. An adversary may attempt to detect and remove the signatures inserted into the watermarked contents without distorting their semantics to exploit the LLM-generated content for malicious usage without being traced.

The machine learning model hosted by the remote cloud 106 may be configured to generate watermarks that are not susceptible to attacks by incorporating adversarial training while watermarking. For example, the decoding module hosted by the remote cloud 106 can be trained to recognize malicious encoded transformations by during training, being fed malicious transforms

For example, an adversary may perform a detection attack by using statistical analysis or machine learning models to detect if texts are watermarked or not.

An adversary may lack prior linguistic knowledge about the LLM output but may perform a text edit attack by randomly deleting, adding, or substituting words within the content, attempting to destroy the watermark while preserving the overall meanings.

An adversary may attempt a text rephrase attack by exploiting open-source NLP models to remove watermarks. By feeding the LLM-generated content into such open-source NLP models, the adversary may generate a rephrased version of the original texts to remove the watermark.

An adversary may attempt a re-watermarking attack in which they dispatch the watermarked texts into another watermarking framework that can re-watermark the text and as such remove the inserted signatures.

The system 100 may be configured to feed the decoding module hosted by the cloud 106 transformations of the LLM output representing these types of malicious attacks so that the watermarks added to the content of the LLM hosted by the remote cloud 106 may be impervious to such attacks.

The encoding module, the reparameterization module, and the decoding module hosted by the remote cloud 106 are trained in an end-to-end manner, with objectives to ensure the semantic similarity of the input text T and the watermarked distribution S(T+M) and to ensure the watermark extraction of the input message M and decoded message M and Mₜ. The first objective is reflected by the semantic loss Lₛ and the second is reflected by the message recovery loss L_{M}.

The system 100 may be configured to formulate the semantic loss L_{S} by minimizing the cross entropy loss between input token T and watermarked text distribution S(T+M) as shown in Equation 2 below. To avoid overfitting, in every epoch, the input token sequence Tis randomly masked via a mask sequence T_{M}. T_{M} is of the same size as T, where 1 means the token is unmasked and 0 means the token is masked. |V| is the size of vocabulary in S and |T| is the number of tokens in the input text T.

$${L}_{S} ( T , 𝒮 ( T \cdot {T}_{M} + M ) ) = - \frac{1}{\vert T \vert} {\sum }_{i = 1}^{\vert T \vert} {\sum }_{j = 1}^{\vert V \vert} {T}_{ij} log ( {𝒮}_{ij} ( T \cdot {T}_{M} + M ) ) \qquad ( 2 )$$

Minimizing L_{S} results in watermarked texts being semantically close to the input texts.

The system 100 may be configured to determine the message recovery loss L_{M} between the input message M and decoded message M from the watermarked distribution using L1 loss. Similarly, the system 100 may be configured to determine the message recovery loss between the signatures decoded from malicious transformation Mₜ and input message M according to Equation 3, in which the two losses are adjusted by the coefficients w_{w} and wₜ.

$${L}_{M} ( M , {M}^{′} , {M}_{t}^{′} ) = {w}_{w} {\sum }_{i = 1}^{\vert M \vert} \vert {M}_{i} - {M}^{′} \vert + {w}_{t} {\sum }_{i = 1}^{\vert M \vert} \vert {M}_{i} - {M}_{t}^{′} \vert \qquad ( 3 )$$

Minimizing L_{M} ensures that the encoded messages can be successfully extracted from the watermarked texts. The losses described by Equations 3 and 4 are included together as an objective function in Equation 4 below during the end-to-end training of the encoding module, the reparameterization module, and the decoding module. The w1 and w2 are the trade-off coefficients during training.

$$L = {w}_{1} {L}_{S} + {w}_{2} {L}_{M} \qquad ( 4 )$$

In some implementations, the system 100 may be further configured to extract the watermark via the message decoding module. Given the watermarked text T̅_{wm}, the decoding module is configured to map the watermarked text into the embedding space using Rₑ. Then, the decoding module may be configured to extract a predicted message M̅′ from T̅_{wm}.

The decoding module may further be configured to compare an extracted predicted message with a watermark M̅ inserted by an LLM proprietor to claim ownership. In other words, the decoding module may be configured to decode the encoded output text sequence to enable verification of ownership of the output text sequence. The confidence in predicting if watermark signatures reside in the watermarked texts can be evaluated, for example, using a z-score. The larger the z-score is, the more robust protection the watermark can provide. Given a message sequence with length |M|, |N| bits out of the message can be successfully detected. The message generation is random and follows binomial distributions, where the probability for generating bit 0 is p=0.5 and bit 1 is 1−p=0.5. The mean of the message distribution can be calculated as μ=|M|×p, and the variance can be calculated as σ²=|M|×p×(1−p). We calculate the z-score of the binominal distribution in Equation 5.

$$z = \frac{\vert N \vert - μ}{σ} . \qquad ( 5 )$$

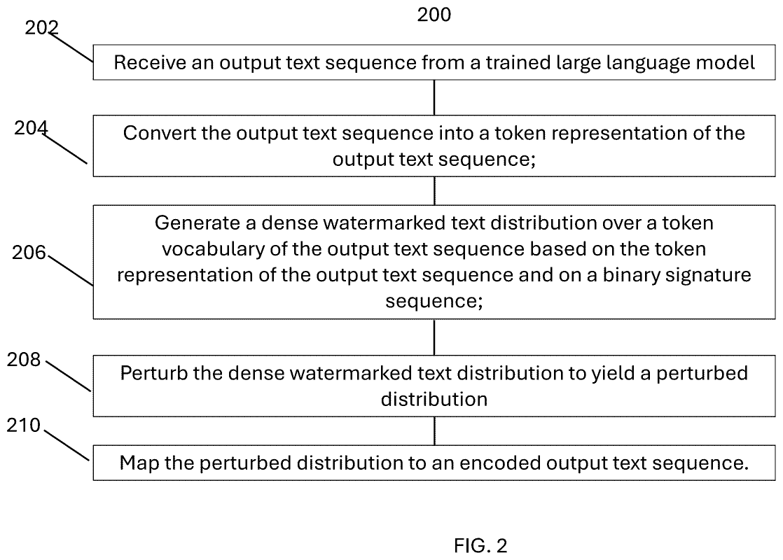

FIG. 2 illustrates a method 200 in accordance with some embodiments described herein. The method 200 may be implemented, for example, by the system 100.

At 202, an output text sequence is received from a large language model, such as a trained large language model. The output text sequence may be received from the trained large language model, such as the LLM 100 depicted at FIG. 1. The LLM may be hosted at a cloud-server, such as the remote cloud 106 of FIG. 1 or at another cloud-server separate from 106. The output text sequence may comprise a sequence of text (e.g., data), such as a response from a prompt to the large language model. The output text sequence from the LLM 1000 may be provided to (e.g., output to) a sequence-to-sequence (Seq2Seq) model. The output text sequence may be received by an encoding module hosted by the remote cloud 106.

At 204 of the method 200, the output text sequence is converted into a token representation of the output text sequence. The output text sequence may be converted into the token representation of the output text sequence by the encoding module hosted by the remote cloud 106 of FIG. 1. The token representation of the output text sequence may comprise a vector representation of the output text sequence. The token representation of the output text sequence may comprise a plurality of tokens. Each of the plurality of tokens of the token representation of the output sequence may represent a corresponding portion of the output text sequence.

At 206, a dense watermarked text distribution over a token vocabulary of the output text sequence is generated, wherein the generating is based on token representation of the output text sequence and on a binary signature sequence. The dense watermarked text distribution may comprise (for each of the plurality of tokens of the token representation of the output text sequence) an associated probability indicative of how the corresponding portion of text transforms. For example, the probabilities associated with each of the plurality of tokens of the token representation may indicate how the corresponding portion of the output text sequence transforms upon incorporation of a watermark into the output text sequence.

At 208, the dense watermarked text distribution is perturbed to yield a perturbed distribution. In some implementations, the dense watermarked text distribution is perturbed by an optimized beam search algorithm. The optimized beam search algorithm may perturb the probabilities associated with each of the plurality of tokens of the token representation. The optimized beam search algorithm may be configured to perturb the dense watermarked text distribution by adding noise to the probabilities of the dense watermarked text distribution. In some implementations, the noise may comprise Gumbel-Softmax noise.

At 210, the perturbed distribution is mapped to an encoded output text sequence. The optimized beam search algorithm may concurrently perturb the probabilities of the dense watermarked text distribution while mapping the perturbed distribution to the encoded output text sequence. The encoded output text may be in the form of a watermarked version of the output text sequence received from the large language model. The encoded output text may differ from the output text sequence while preserving the semantic fidelity of the output text sequence. The watermark may be extracted from the encoded output text to verify ownership of the output text sequence received from the large language model.

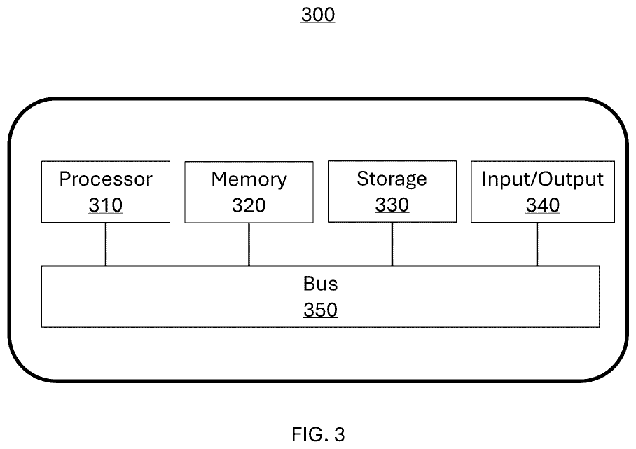

FIG. 3 depicts a block diagram illustrating a computing system 300 consistent with implementations of the current subject matter. For example, the system 300 can be used to host the system 100 of FIG. 1. The system 300 may be configured to implement the method 200 (e.g., a computer-implemented method).

As shown in FIG. 3, the computing system 300 can include a processor 310, a memory 320, a storage device 330, and input/output devices 340. The processor 310, the memory 320, the storage device 330, and the input/output devices 340 can be interconnected via a system bus 350. The processor 310 may be capable of processing instructions for execution within the computing system 300. In some embodiments, the system 300 provides an encoding module (which causes or executes among other things the receiving an output text sequence from a trained large language model, converting the output text sequence into a token representation of the output text sequence, and generating a dense watermarked text distribution over a token vocabulary of the output text sequence, the generating based on the token representation of the output text sequence and on a binary signature sequence) and an optimization beam search module (which causes or executes among other things perturbing the dense watermarked text distribution to yield a perturbed distribution and mapping the perturbed distribution to an encoded output text sequence), and a reparametrizing module (which causes or executes among other thing the dense watermarked text distribution over the token vocabulary of the output text sequence to a yield a sparse distribution).

In some implementations of the current subject matter, the processor 310 can be at least one single-threaded processor, at least one multi-threaded processor, at least one graphic processor unit (GPU), at least one AI (or machine learning) chip/processor, and/or the like. The processor is configured to process instructions stored in the memory and/or on the storage device to display graphical information for a user interface provided via the input/output device. The memory is a computer readable medium such as volatile or non-volatile that stores information within the computing system. The storage device is capable of providing persistent storage for the computing system. The storage device can be a floppy disk device, a hard disk device, an optical disk device, or a tape device, or other suitable persistent storage means. The input/output device provides input/output operations for the computing system. In some implementations of the current subject matter, the input/output device includes a keyboard and/or pointing device. In various implementations, the input/output device includes a display unit for displaying graphical user interfaces. According to some implementations of the current subject matter, the input/output device can provide input/output operations for a network device. For example, the input/output device can include Ethernet ports or other networking ports to communicate with one or more wired and/or wireless networks (e.g., a local area network (LAN), a wide area network (WAN), the Internet).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium (e.g., non-transitory computer-readable storage medium) can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed:

1. A system comprising:
at least one processor; and
at least one memory including instructions which when executed by the at least one processor causes operations comprising:
receiving an output text sequence from a trained large language model;
converting the output text sequence into a token representation of the output text sequence;
generating a dense watermarked text distribution over a token vocabulary of the output text sequence, the generating based on the token representation of the output text sequence and on a binary signature sequence;
perturbing the dense watermarked text distribution to yield a perturbed distribution; and
mapping the perturbed distribution to an encoded output text sequence.

2. The system of claim 1, wherein the receiving, the converting, and the generating are caused to be performed by an encoding module, and wherein the perturbing and the mapping are caused to be performed by an optimization beam search module.

3. The system of claim 1, wherein the token representation of the output text sequence comprises a plurality of tokens, each of the plurality of tokens representing a corresponding portion of text of the output text sequence.

4. The system of claim 3, wherein the dense watermarked text distribution comprises, for each of the plurality of tokens, an associated probability indicative of how the corresponding portion of text maps to the encoded output text sequence.

5. The system of claim 4, wherein perturbing comprises adding noise to the dense watermarked text distribution.

6. The system of claim 5, wherein the noise comprises Gumbel-Softmax noise.

7. The system of claim 1, further comprising reparametrizing the dense watermarked text distribution over the token vocabulary of the output text sequence to a yield a sparse distribution.

8. The system of claim 7, wherein a reparameterization module causes the reparametrizing.

9. The system of claim 1, further comprising decoding the encoded output text sequence to enable ownership verification of the output text sequence.

10. A computer-implemented method comprising:
at least one processor; and
at least one memory storing instructions that, when executed by the at least one processor, cause the at least one processor to perform operations comprising:
receiving an output text sequence from a trained large language model;
converting the output text sequence into a token representation of the output text sequence;
generating a dense watermarked text distribution over a token vocabulary of the output text sequence, the generating based on the token representation of the output text sequence and on a binary signature sequence;
perturbing the dense watermarked text distribution to yield a perturbed distribution; and
mapping the perturbed distribution to an encoded output text sequence.

11. The computer-implemented method of claim 10, wherein the receiving, the converting, and the generating are caused to be performed by an encoding module, and wherein the perturbing and the mapping are caused to be performed by an optimization beam search module.

12. The computer-implemented method of claim 10, wherein the token representation of the output text sequence comprises a plurality of tokens, each of the plurality of tokens representing a corresponding portion of text of the output text sequence.

13. The computer-implemented method of claim 12, wherein the dense watermarked text distribution comprises, for each of the plurality of tokens, an associated probability indicative of how the corresponding portion of text maps to the encoded output text sequence.

14. The computer-implemented method of claim 13, wherein perturbing comprises adding noise to the dense watermarked text distribution.

15. The computer-implemented method of claim 14, wherein the noise comprises Gumbel-Softmax noise.

16. The computer-implemented method of claim 10, further comprising reparametrizing the dense watermarked text distribution over the token vocabulary of the output text sequence to a yield a sparse distribution.

17. The computer-implemented method of claim 16, wherein a reparameterization module causes the reparametrizing.

18. The computer-implemented method of claim 10, further comprising decoding the encoded output text sequence to enable ownership verification of the output text sequence.

19. A non-transitory machine-readable medium storing instructions that, when executed by at least one processor, cause the at least one processor to perform operations comprising:
receiving an output text sequence from a trained large language model;
converting the output text sequence into a token representation of the output text sequence;
generating a dense watermarked text distribution over a token vocabulary of the output text sequence, the generating based on the token representation of the output text sequence and on a binary signature sequence;
perturbing the dense watermarked text distribution to yield a perturbed distribution; and
mapping the perturbed distribution to an encoded output text sequence.

20. The non-transitory machine-readable medium of claim 19, wherein the receiving, the converting, and the generating are caused to be performed by an encoding module, and wherein the perturbing and the mapping are caused to be performed by an optimization beam search module.
